(19) United States
(12) Patent Application Publication
(10) Pub. No.: US 2026/0237248 A1
(43) Pub. Date: Aug. 13, 2026

(54) PORTABLE AUTOMOTIVE DIAGNOSTIC SYSTEM WITH SEAMLESS TOOL INTEGRATION AND CONFIGURATION

(71) Applicant: Innova Electronics Corporation, Irvine, CA (US)

(72) Inventor: Peter Centeno, West Covina, CA (US)

(21) Appl. No.: 19/050,871

(22) Filed: Feb. 11, 2025

(51) Int. Cl. G07C 5/00; G07C 5/08

(52) U.S. Cl. CPC G07C 5/008; G07C 5/0808; G07C 2205/02

(57) ABSTRACT

A method and system for vehicle diagnostics using a portable system includes a hand-held device, configured to be linked to a plurality of diagnostic tools contained within a portable housing such as backpack or any other suitable housing that can be conveniently carried by the users. The hand-held device receives a vehicle identification information such as VIN, model number, engine number or license plate, sends it to a remote server, and retrieves tool configuration parameters specific to the vehicle. The hand-held device establishes tool profiles and automatically configures the tools to perform vehicle-specific diagnostics. The system is configured to link diagnostic tools to the hand-held device, which orchestrates their operation. The hand-held device or remote resources evaluate tool data to determine whether additional tools should be linked, reconfigured to acquire more diagnostic information or adjust vehicle parameters. The system enables real-time evaluation, troubleshooting, and automatic adjustments of diagnostic tools.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present invention relates to the field of vehicle diagnostics, specifically to a portable system that integrates various diagnostic tools and automates their configuration and operation for vehicle maintenance and troubleshooting. More particularly, the invention addresses the challenges faced by automotive repair technicians and roadside assistance professionals when performing diagnostics on a vehicle using multiple tools in mobile or remote settings.

### 2. Description of the Related Art

As the complexity of modern vehicles increases, many consumers find it difficult to perform basic diagnostics or maintenance without relying on professional technicians. Traditionally, diagnostic systems have been cumbersome, requiring users to manually configure individual diagnostic tools to access specific vehicle data. For example, a vehicle owner may need separate tools such as an OBD-II scanner, tire inflator, battery tester, and other specialized equipment to perform a comprehensive check-up. Each of these tools typically requires its own configuration and operation, which can be time-consuming and confusing, especially for individuals without specialized knowledge or training.

While some portable diagnostic systems are available, many still require the user to manually manage different devices, interpret complex diagnostic data, and make adjustments based on their own judgment. This often leads to errors or missed issues, particularly in emergency situations where immediate assistance is needed.

Existing systems also fail to integrate diagnostic tools seamlessly. For instance, a consumer may need to separately use a tire inflator, check tire pressure, and manually adjust it to meet the vehicle's specifications. Similarly, if a battery issue is detected, the user must manually connect a battery tester or jumper cables and make adjustments without clear guidance. Many of these systems also lack real-time feedback, remote support, or cloud-based capabilities to help consumers perform diagnostics with confidence or access immediate expert assistance.

Attempts to create portable diagnostic solutions, such as backpacks or portable kits, have been made, but these systems often serve only as passive storage, providing easy access to tools without automating the diagnostic process. While offering mobility, these devices don't address the primary challenge: simplifying diagnostics and providing real-time, data-driven guidance that consumers can follow without technical expertise.

Even systems that provide connectivity between diagnostic tools and a central device, such as a smartphone or tablet, still require the user to manually switch between tools, configure them for each specific task, and interpret results on their own. This increases the likelihood of mistakes, especially under time pressure or in an emergency.

The present invention addresses the limitations of current users' vehicle diagnostic systems by introducing a portable and/or wearable solution that autonomously manages multiple diagnostic tools and provides real-time, user-friendly guidance for vehicle maintenance and troubleshooting. The system includes a central hand-held device that automatically configures the diagnostic tools, orchestrates their use, and adjusts vehicle parameters based on real-time data collected from the vehicle. This eliminates the need for consumers to manually configure each tool or interpret complex results, simplifying the process significantly.

Consumers no longer need to switch between tools or guess how to make the right adjustments—the portable, integrated system handles it all.

A key innovative feature of the invention is its ability to coordinate multiple tools simultaneously, providing seamless operation across various vehicle subsystems. For example, while checking tire pressure, the system can also monitor the vehicle's battery and sensors in real time. The hand-held device presents the collected data in an easy-to-understand format and recommends or automatically makes necessary adjustments to ensure the vehicle operates optimally. This integration reduces the time and effort needed to diagnose and repair common vehicle issues.

The portable and/or wearable nature of the system is another key innovation. Housed in a backpack-like device, the diagnostic system is easy to carry and store. Its compact design allows users to mimic a shop environment and to take the diagnostic tools anywhere—whether in the car, on a road trip, or for emergency roadside repairs. The system also includes a central power source to charge both the hand-held device and diagnostic tools, ensuring they are always ready for use.

Additionally, the invention incorporates cloud-based connectivity, enabling the system to store diagnostic data and generate reports that can be accessed remotely. This is particularly useful in emergency situations, allowing the consumer to send diagnostic data to a remote technician or receive real-time guidance through a mobile app, ensuring expert assistance is always available when needed. The system further allows the user to access tool configuration and calibration information from remote server that is specific to the vehicle under inspection or repair. Hence the same set of diagnostic tools can be automatically configured specific to the vehicle or based on the last diagnostic reports available on remote server.

In conclusion, the present invention provides a portable, user-friendly vehicle diagnostic system designed for consumers. By integrating multiple diagnostic tools into a cohesive system that automatically configures and operates based on the real-time needs of the vehicle, this invention significantly enhances the convenience and accuracy of vehicle diagnostics. Whether used for routine maintenance or emergency roadside repairs, this system gives users the confidence and convenience to troubleshoot and address vehicle issues without specialized technical knowledge. The wearable and portable design, combined with real-time data analysis and cloud-based support, offers a significant improvement over existing solutions and opens up new possibilities for consumer-level vehicle diagnostics.

### BRIEF SUMMARY

The present invention provides a portable, automated vehicle diagnostic system designed for consumers, combining a hand-held device with a range of diagnostic tools to offer efficient, real-time diagnostics and maintenance. This system is particularly suited for on-the-go vehicle diagnostics, including emergency roadside repairs, roadside assistance, or mobile mechanic services, offering a practical solution for vehicle owners who need to perform diagnostics outside of a traditional service environment.

The system mimics a shop environment, where diagnostic tools link to the hand-held device, which orchestrates their operation and functionality for vehicle-specific diagnostics. The process begins by identifying the vehicle, either through scanning the vehicle's identification vehicle identification information such as VIN, model number, engine number, license plate, or connecting directly to the vehicle's onboard diagnostic (OBD) port. Once the vehicle is identified, the hand-held device registers the diagnostic tools and creates profiles for each tool, detailing its name, function, and the specific data it collects.

Upon selecting a diagnostic function, the hand-held device automatically configures and links the appropriate tools. Information accessed by each diagnostic tool is evaluated by the hand-held device, which can determine whether additional tools should be connected or reconfigured to acquire more diagnostic data or adjust vehicle parameters for optimal performance. For example, if the system detects low tire pressure, it may automatically adjust the tire inflator or reprogram the tire pressure sensor as needed.

The tools are plug-and-play, automatically detected and configured when connected, either through wired or wireless communication. This simplifies the setup process, offering a seamless user experience. Additionally, the system leverages cloud-based connectivity to store diagnostic data and enable real-time remote support from technicians. Remote assistance allows consumers to receive expert guidance and make necessary adjustments, improving diagnostic accuracy and efficiency.

Designed to be portable, the system can be housed in a wearable backpack or any other form of portable housing with compartments for each tool and an integrated power source for charging the hand-held device and diagnostic tools. The backpack allows for easy transportation and use in various environments, including roadside repairs or emergency situations. It may also include a communication system for real-time interaction with remote resources and GPS functionality to assist technicians with location-specific support.

Further enhancing the system's functionality, the hand-held device automatically updates diagnostic tool profiles with new software or firmware, ensuring the system remains up to date. The hand-held device generates detailed diagnostic reports that include vehicle condition data, tool performance, and suggested adjustments. These reports can be stored locally/remote server or sent to remote technicians for further analysis. Additionally, the system tracks the usage history of each diagnostic tool, optimizing tool performance over time.

In summary, the present invention offers a comprehensive, portable, and cloud-connected solution for vehicle diagnostics, emergency repairs, and routine maintenance. It simplifies the diagnostic process by automating tool configuration, providing real-time support, and improving the overall accuracy and efficiency of vehicle diagnostics. With its wearable design, cloud-based connectivity, and seamless integration of diagnostic tools, this system is an innovative and convenient solution for modern vehicle owners, whether performing diagnostics at home, on the road, or in emergency situations. This invention represents a significant advancement in consumer vehicle maintenance, offering a flexible, intelligent, and user-friendly diagnostic toolset.

One aspect of the embodiments of the present disclosure is a method for performing vehicle diagnostics using a portable system. The portable system may include a hand-held device disposed within a backpack and communicatively coupled to a plurality of diagnostic tools. The plurality of diagnostic tools may also be disposed within a backpack. The method may comprise receiving a vehicle identification information for a vehicle under test, wirelessly obtaining tool configuration parameters associated with the vehicle under test, establishing a tool profile associated with at least one of the diagnostic tools, the profile including a unique identifier associated with the diagnostic tool, wirelessly configuring one or more of the diagnostic tools to implement a diagnostic function on the vehicle under test based on the selected diagnostic function associated with the diagnostic tool, and uploading a diagnostic report associated with the implemented diagnostic function, to a remote server.

The vehicle identification information may be received by scanning a VIN label using a camera integrated into the hand-held device. The vehicle identification information may be received by connecting the hand-held device or portable housing to vehicle's diagnostic port. The vehicle identification information may be sent to a remote server. The tool configuration parameters may also be retrieved from the remote server and may include at least one of tire pressure settings, battery voltage, oil levels, or sensor calibration data specific to the associated vehicle. The diagnostic tools may be selected from the group consisting of a tire inflator, a battery jump starter, battery tester, OBD-II scanner, basic tools, electric tester, a climate control device, an engine analyzer, and a fuel injector tester. Configuring the diagnostic tool may include altering or resetting the tool's settings in relation to the identified vehicle. The diagnostic tools may include a tire inflator wherein the tire inflator is configured by the hand-held device to achieve a predetermined tire pressure. The diagnostic tools may include a battery jump starter wherein the battery jump starter is configured to deliver a required voltage or current suitable for jump-starting the vehicle's battery. The climate control device may be used to diagnose or adjust the vehicle's heating, ventilation, or air conditioning (HVAC) system, and the hand-held device may automatically configure the climate control device's settings based on the vehicle's specific HVAC specifications. The diagnostic tools may be plug-and-play devices that automatically communicate with the hand-held device upon being physically connected or wirelessly linked. Establishing a tool profile with the hand-held device may comprise storing a unique identifier for each diagnostic tool, the unique identifier being used to track the tool's usage and performance data. The diagnostic tool may be further configured to store the retrieved tool configuration parameters locally on the hand-held device for use in the absence of connectivity to the remote server. The diagnostic report uploaded to the remote server may include information about the status of the vehicle's tires, engine, battery, and other key vehicle systems.

The method may comprise using a cloud-based system being accessible by the hand-held device for further analysis or for sharing with a remote technician. The hand-held device may be configured to automatically update the diagnostic tool profile whenever new tool configuration parameters are retrieved from the remote server. The diagnostic function may include checking the health of a specific vehicle component, such as monitoring tire pressure or battery voltage. The uploaded diagnostic report may include a status update on that specific component. The hand-held device may be configured to display, in addition to the selected diagnostic tool(s), a status indicator for each tool, the status indicator showing whether the tool is ready to perform a diagnostic function, in use, or requires maintenance. The hand-held device may be selected from the group consisting of an On-Board Diagnostics (OBD) scanner and a mobile communication device capable of wirelessly connecting to the diagnostic tools. The system may comprise a wearable backpack to house the hand-held device and diagnostic tools, the backpack having compartments for each tool and providing power to the tools through an integrated power source. The wearable backpack may include dedicated compartments for securely storing each diagnostic tool, a power source for charging the hand-held device and tools, and one or more connectors for establishing communication between the hand-held device and the diagnostic tools. The wearable backpack may be designed to be lightweight and may be configured for ease of use by a technician or user while performing diagnostics on a vehicle in a roadside or mobile environment. The portable system may include a GPS unit that allows the system to track the location of the vehicle being diagnosed, enabling remote technicians to provide location-based assistance or to dispatch additional resources if necessary.

Another aspect of the embodiments of the present disclosure is a method for performing vehicle diagnostics using a portable system. The method may comprise a hand-held device communicatively coupled to a plurality of diagnostic tools, wherein the plurality of diagnostic tools is secured within a housing, wherein each of the diagnostic tool is associated with the unique tool identifier that identifies functionality associated with that tool and the hand-held device is configured for: receiving a vehicle identification information, sending the vehicle identification information to a remote server, receiving tool configuration parameters specific to an associated vehicle from the remote server, receiving an instruction to collect vehicle information report for an associated vehicle, and, in response to the instruction and based on an evaluation of the collected vehicle information report, performing at least one of: re-configuring one or more diagnostic tools or recommending adjustments to a vehicle operating parameter.

The instruction to collect a vehicle information report may be triggered by a diagnostic tool detecting an issue with a vehicle component. The instruction to collect a vehicle information report may be received from a remote technician who reviews the initial diagnostic data and requests additional information about the vehicle's status. The reconfiguration of one or more diagnostic tools may include adjusting the settings of a tire inflator to target a specific tire pressure based on the retrieved vehicle configuration parameters. The recommendation to adjust a vehicle operating parameter may include recommending a change to at least one of tire pressure, engine settings, sensor calibration or fuel mixture to optimize vehicle performance. The evaluation of the collected vehicle information report may be performed by a remote server, which analyzes the vehicle's data and provides instructions for reconfiguring the diagnostic tools or adjusting vehicle parameters. The reconfiguration of one or more diagnostic tools may be automatically performed by the hand-held device, based on the evaluation of the vehicle information report. The adjustment to a vehicle operating parameter may be made by sending a command to the vehicle's On-Board Diagnostics (OBD) system to recalibrate or modify specific parameters, such as tire pressure, vehicle's heating, ventilation, air conditioning (HVAC) system or engine performance. The hand-held device may generate a feedback report after performing the adjustments, and the feedback report may be uploaded to the remote server for further analysis by a technician. The vehicle information report may include diagnostic data from multiple diagnostic tools, and the report may be used to generate a list of recommended repairs or maintenance actions based on the collected data. The diagnostic function may include checking the health of the vehicle's battery, and the recommendation to adjust a vehicle operating parameter may include adjusting the battery charger settings to safely charge the battery. The hand-held device may be configured to suggest additional diagnostic tools based on the specific functionality required for the vehicle, the suggestion being made based on the diagnostic tools already connected and the vehicle data obtained. The hand-held device may be further configured to send alerts to a remote technician or user, if the diagnostic tools detect issues outside predetermined thresholds, allowing for real-time remote troubleshooting or guidance. The vehicle operating parameters may be adjusted automatically based on the data collected, or the hand-held device may provide step-by-step instructions to a user for manual adjustment of the vehicle operating parameters.

The diagnostic tools may be each associated with a specific function, and the method may comprise determining which functions are necessary for the specific vehicle under test before selecting the corresponding tools. The hand-held device may display real-time diagnostic information from the selected diagnostic tool(s), including settings such as tire pressure, battery voltage, or HVAC system status, and may provide recommendations for adjustments based on the vehicle's specific needs. The diagnostic tools may be configured to store and upload data to the hand-held device for analysis, and the hand-held device may be capable of adjusting the tool configurations remotely to optimize the diagnostic process based on the collected data. The portable diagnostic system may be housed within a wearable backpack, the backpack configured to carry and organize the various diagnostic tools, and the system may be adapted for use as an on-the-go road assistance system for individuals requiring vehicle diagnostics or emergency assistance.

Another aspect of the embodiments of the present disclosure is a portable vehicle diagnostic system. The portable vehicle diagnostic system may comprise a hand-held device secured within a housing and configured to communicate with a plurality of diagnostic tools, the diagnostic tools being also secured within a housing, the hand-held device configured to receive a vehicle identification information, wirelessly obtain tool configuration parameters specific to an associated vehicle under test, establish a tool profile for the plurality of diagnostic tools, the profile including a unique identifier associated with each diagnostic tool, configure one or more diagnostic tools based on the retrieved tool configuration parameters to perform a diagnostic function, and upload a diagnostic report associated with the implemented diagnostic function to a remote server.

The hand-held device may be further configured to receive an instruction to collect a vehicle information report for an associated vehicle, and based on the evaluation of the collected vehicle information report, the hand-held device may be configured to perform at least one of: reconfiguring one or more diagnostic tools, or recommending adjustments to a vehicle operating parameter. The diagnostic tools may include at least one of a tire inflator, a battery jump starter, battery tester, OBD-II scanner, basic tools, electric tester, a climate control device, an engine analyzer, and a fuel injector tester. The hand-held device may be configured to track the performance and usage history of each diagnostic tool and automatically prompt for maintenance or firmware updates when needed. The portable system may include GPS functionality to transmit location data to a remote technician or diagnostic server for real-time assistance. The hand-held device may be configured to reconfigure diagnostic tools to acquire additional diagnostic information upon receiving a request from a remote technician. The housing may be a wearable backpack that includes compartments for securely storing the diagnostic tools and an integrated power source to charge both the hand-held device and diagnostic tools. The hand-held device may be configured to establish communication with the remote server over a wireless network, including cellular data or Wi-Fi. The diagnostic report uploaded to the remote server may include vehicle-specific parameters such as tire pressure, battery voltage, engine health, and sensor calibration. The instruction to collect a vehicle information report may be triggered by a diagnostic tool identifying a potential issue with the vehicle. The hand-held device may be configured to automatically make adjustments to the vehicle operating parameters based on the evaluation of the vehicle information report, including adjustments to engine idle speed, fuel injection, or tire pressure. The diagnostic tools may be capable of receiving configuration updates remotely from the cloud-based server to ensure the tools have the latest diagnostic capabilities. The diagnostic tools may be configured to interface with the vehicle's On-Board Diagnostics (OBD) port to retrieve data directly from the vehicle's ECU. The hand-held device may be configured to allow a remote technician to provide real-time feedback or step-by-step troubleshooting instructions based on the uploaded diagnostic report.

Another aspect of the embodiments of the present disclosure is a wearable backpack assembly for diagnosing a vehicle. The wearable backpack assembly may comprise a housing having a recessed area defining a plurality of storage cavity, a tire inflator disposed within the housing, a battery jump-start system disposed within the housing, the system comprising jumper cables and a built-in tester, a hand-held device removably disposed within the housing communicatively coupled with a modular OBD-II dongle, and a removable magnetic tray secured to the housing via a locking mechanism, the locking mechanism being selected from the group consisting at least one of a latch-based system, a sliding groove system, or a rail system, wherein the removable magnetic tray is configured to store plurality of tools and/or vehicle parts.

The hand-held device may comprise a display screen configured to present diagnostic information to a user. The modular OBD2 dongle may be removably connected to the vehicle and may be configured for wireless communication with the handheld device. The removable magnetic tray may be configured to store a plurality of tools selected from the group consisting of wrenches, screwdrivers, pliers, and electrical testers. The removable magnetic tray may include dedicated compartments for organizing tools, parts, and consumables, minimizing the risk of tool damage or loss. The tire inflator may be configured to support a variety of valve types, including Schrader and Presta valves. The battery jump-start system may include a charging port for recharging external devices. The tire inflator may be communicatively coupled with tire pressure monitoring system (TPMS) sensors for real-time monitoring and adjustment of tire pressure. The hand-held device may be configured to wirelessly connect to a remote server for storing diagnostic data and accessing tool configuration updates. The modular OBD2 dongle may include a wireless communication interface for retrieving diagnostic trouble codes (DTCs) and resetting vehicle modules. The locking mechanism securing the magnetic tray may be equipped with a quick-release feature for rapid detachment during repairs or diagnostics. The housing may include weather-resistant materials and shock-absorbing padding to protect the internal components from environmental and physical damage. The hand-held device may include a built-in camera for scanning vehicle identification numbers (VIN) or other barcodes for vehicle-specific diagnostics. The backpack assembly may comprise an integrated GPS unit for tracking the location of the assembly during emergency roadside diagnostics.

Another aspect of the embodiments of the present disclosure is a method for performing vehicle diagnostics using a wearable backpack system including a detachable magnetic tray. The method may comprise securing a plurality of diagnostic tools within the backpack, wherein the plurality of diagnostic tool includes: an integrated tire inflator coupled with TPMS sensors for real-time tire pressure monitoring and inflation, a battery jump-start system with a built-in tester, and a wireless vehicle communication interface (VCI) disposed into housing for remote diagnostic connectivity, the method further comprising receiving vehicle identification information, via a hand-held device stored within the backpack and communicatively coupled with a modular OBD2 dongle, wirelessly obtaining tool configuration parameters for the plurality of diagnostic tools housed in the backpack and obtaining vehicle data associated with the vehicle, and automatically configuring the diagnostic tools to perform diagnostic functions on the vehicle.

The diagnostic tools may include an integrated tire inflator capable of achieving a predetermined pressure based on vehicle specifications. The tire inflator may be configured to automatically adjust tire pressure to a pre-set value based on vehicle specifications retrieved from the modular OBD-II dongle. The OBD-II system may be wirelessly connected to a cloud-based platform for storing and analyzing vehicle diagnostic data. The GPS functionality may provide location tracking for roadside assistance and may integrate with the diagnostic tools for precise troubleshooting. The hand-held device may automatically synchronize with the diagnostic tools to create a unified tool configuration profile. Reports generated by the diagnostic tools may include tire pressure data, battery health, and error codes, and may be accessible via a remote server or mobile app. The diagnostic tools may be automatically updated via over-the-air (OTA) updates from the cloud-based platform. Receiving vehicle identification information may comprise scanning a vehicle identification number (VIN) using a camera integrated into the hand-held device. The magnetic tray may be detachable and maybe include a built-in interface for securely connecting to additional diagnostic modules or accessories. The battery jump-start system may be configured to assess the vehicle's battery health and provide tailored recommendations for maintenance or replacement. The diagnostic process may include generating a detailed report encompassing tire pressure, battery status, and error codes, accessible via a mobile application linked to the backpack system.

### BRIEF DESCRIPTION OF THE DRAWINGS

These and other features and advantages of the various embodiments disclosed herein will be better understood with reference to the following description and drawings, in which like reference numbers refer to like parts throughout, and in which:

FIG. 1 shows a system for performing vehicle diagnostics according to an embodiment of the present disclosure;

FIG. 2 shows a sequence of screenshots of a hand-held device according to an embodiment of the present disclosure, in relation to obtaining vehicle-specific information;

FIG. 3 shows a sequence of screenshots of a hand-held device in relation to registering a plurality of diagnostic tools;

FIG. 4 shows an example operational flow according to an embodiment of the present disclosure;

FIG. 5 shows an example sub-operational flow of step 405 in FIG. 4;

FIG. 6 shows an exemplary design of a portable backpack housing according to an embodiment of the present disclosure;

FIG. 6 (a) & FIG. 6 (b) illustrates two alternative configurations of the portable backpack housing according to an embodiment of the present disclosure;

FIG. 7 illustrates an exemplary battery toolkit housed within the portable backpack housing, in accordance with an embodiment of the present disclosure.

FIG. 8 demonstrates an exemplary diagnostic toolkit housed within the portable backpack housing, according to an embodiment of the present disclosure.

### DETAILED DESCRIPTION

The present disclosure provides an advanced, portable vehicle diagnostic system that integrates a variety of diagnostic tools to enable comprehensive, real-time diagnostics, maintenance, and troubleshooting of vehicles. The system is specifically designed for a broad range of use cases, from roadside assistance and mobile mechanic services to remote diagnostics in hard-to-reach areas. It offers a highly flexible and efficient solution for both consumers and professionals, combining cloud-based connectivity, automatic tool configuration, and real-time diagnostic capabilities. The result is a seamless, intuitive system that simplifies vehicle diagnostics and repairs, making it both user-friendly and highly effective.

The detailed description below, in connection with the appended drawings, is intended to describe several currently contemplated embodiments and is not intended to limit the disclosed invention to a specific form or use. The description sets forth the functions and features in relation to the illustrated embodiments. However, it is understood that the same or equivalent functions may be accomplished by different embodiments that are within the scope of the present disclosure. Additionally, the use of relational terms is used solely to distinguish one entity from another and do not necessarily imply any actual relationship or order between such entities.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Vehicle On-Board Diagnostic Systems (OBDs) are electronic systems in vehicles that monitor and regulate various engine and emission control components to ensure optimal performance and compliance with environmental standards. Originally developed in the 1980s, OBD systems were designed to help technicians diagnose issues by providing access to information from the vehicle's control modules. OBD-I (On-Board Diagnostics I) was a first generation OBD system implemented in vehicles. It was introduced primarily in the 1980s and became mandatory in the United States in 1991 by the California Air Resources Board (CARB) to monitor and control vehicle emissions. However, OBD-I was not a unified or fully standardized system in the way that OBD-II is today. The introduction of the OBD-II standard in 1996 in the United States made it mandatory for all cars to have a universal diagnostic system that could communicate standardized codes, known as Diagnostic Trouble Codes (DTCs), to identify specific malfunctions. OBD systems monitor the engine, transmission, emissions controls, and other crucial systems, and they can alert the driver with a “Check Engine” or similar warning light when a fault is detected. This technology allows mechanics and vehicle owners to diagnose and address problems quickly using an OBD scanner, improving vehicle reliability, safety, and environmental performance.

Standard DTCs associated with relay issues often fall under the P, B, and C code categories, which relate to the powertrain, body, and chassis systems respectively. Here are some of the common DTCs associated with relay issues:
P0685-P0691 (ECM/PCM Relay Control Circuit): These codes indicate problems with the powertrain control module (PCM) or engine control module (ECM) relay circuits. They typically refer to the ECM or PCM's inability to control the relay properly, often pointing to a faulty relay, wiring issue, or internal failure.
P0480-P0483 (Cooling Fan Relay Circuits): These codes are associated with the cooling fan relay or the fan's control circuit. A faulty relay, open or shorted circuit, or a failed fan control module could trigger these codes.
P0230-P0233 (Fuel Pump Relay Circuit): These codes indicate an issue with the fuel pump relay or its control circuit. Problems such as a faulty relay, wiring problems, or PCM issues could cause these codes to appear.
B1370-B1374 (Various Body Control Module Relay Faults): These codes are associated with relays controlling body-related systems, such as power windows, door locks, or interior lighting. Issues might stem from faulty relays, BCM malfunctions, or wiring issues.
C1032-C1036 (Chassis System Relay Issues): These codes indicate problems with relays controlling chassis-related functions, such as ABS or traction control systems.

Additional information is available from an OBD port in addition to DTC codes. Real-time data and snapshot data from an OBD-II port can offer valuable insights into potential relay issues in a vehicle. The OBD-II system, while primarily focused on engine and emissions-related monitoring, also captures information from control modules that can indicate relay malfunctions. For instance, live voltage readings from various circuits and sensors can help detect whether a relay is failing to provide consistent voltage or if an abnormal current draw is occurring. Additionally, real-time data can show relay activation status, which indicates whether critical relays such as those controlling the fuel pump, cooling fans, or HVAC blower motor are being properly commanded to open or close. The ECM or BCM can report whether the relay's activation signal matches expected operations. This is useful when checking component state information, which can highlight issues if data shows that components reliant on relays, like cooling fans or AC compressors, are not activating as expected. Temperature and pressure data from sensors, such as the engine coolant temperature sensor or the transmission fluid temperature sensor, may reveal abnormal conditions, indicating that a relay controlling a fan or pump is malfunctioning.

Snapshot or real-time data, captured after a DTC is triggered, records the vehicle's operating conditions. This data might include relay command status, voltage levels, and other parameters relevant to the malfunction. For example, if a cooling fan-related DTC is triggered, freeze frame data could reveal if the relay was commanded to activate, along with details like coolant temperature and fan speed. Voltage and ground readings at the time a fault code was set can also indicate a problem with the relay affecting power or ground connections to a component. For relays controlling components via pulse-width modulation (PWM), snapshot data can capture duty cycle percentages or load values, which could indicate relay or circuit issues if they are abnormal. For more information regarding the retrieval and analysis of vehicle data, please refer to the following U.S patents and published patent applications, owned by Innova Electronic Corporation, which is also the owner of the present disclosure: U.S. Pat. No. 6,807,469, entitled AUTO DIAGNOSTIC METHOD AND DEVICE, U.S. Pat. No. 6,925,368, entitled AUTO DIAGNOSTIC METHOD AND DEVICE, U.S. Pat. No. 7,620,484, entitled AUTOMOTIVE MOBILE DIAGNOSTICS, U.S. Pat. No. 8,019,503, entitled AUTOMOTIVE DIAGNOSTIC AND REMEDIAL PROCESS, U.S. Pat. No. 8,370,018, entitled AUTOMOTIVE DIAGNOSTIC PROCESS, U.S. Pat. No. 9,177,428, entitled PREDICTIVE DIAGNOSTIC METHOD, U.S. Pat. No. 11,068,560, entitled METHOD OF PROCESSING VEHICLE DIAGNOSTIC DATA, U.S. patent application Ser. No. 12/112,587 entitled SYSTEM AND METHOD FOR GUIDED VEHICLE DIAGNOSTICS, U.S. patent application Ser. No. 11/915,534 entitled VEHICLE DIAGNOSTICS WITH INTELLIGENT COMMUNICATION INTERFACE, the entire contents of each of which is expressly incorporated herein by reference.

Technicians can use OBD-II scanners to view live data streams and snapshot data, focusing on parameters like voltage, current, relay command status, and sensor readings. This helps correlate data with vehicle symptoms to identify if a relay is not engaging or disengaging properly. Analyzing data alongside triggered DTCs enables technicians to pinpoint the root cause of an issue, whether it's a relay fault, corroded terminals, or wiring problems. Real-time and snapshot data from the OBD-II system thus offer a detailed view of relay and circuit functionality, aiding in efficient diagnosis and resolution of relay-related problems.

To obtain DTCs and data related to relay issues from an OBD-II system, specific Parameter IDs (PIDs) and OBD-II modes are used. Example modes for securing relay information are as follows:
Mode 03: Request DTCs retrieves stored DTCs from control modules like the ECM, TCM, and BCM, displaying active or pending relay-related codes.
Mode 07: Request Pending DTCs identifies pending DTCs for intermittent relay issues not yet confirmed as permanent faults.
Mode 02: Freeze Frame Data provides a snapshot of vehicle conditions (e.g., RPM, coolant temperature, sensor voltage) at the moment a DTC was triggered, aiding in diagnosing relay circuit malfunctions.
Mode 01: Real-Time Data uses PIDs to access live readings (e.g., Battery Voltage PID 42, Engine Coolant Temperature PID 05, relay status PIDs). It shows voltage, relay activation states, and commanded actuator states for diagnostics.
Mode 09: Vehicle Information retrieves the VIN, ECU software version, and calibration data to verify vehicle specifics, ensuring correct relay circuit analysis.
Mode 06: On-Board Monitoring gives detailed results for specific components, including voltage and resistance checks on relay circuits. It shows tests for systems like cooling fan and fuel pump relays, confirming if they operate within parameters.

### System Overview

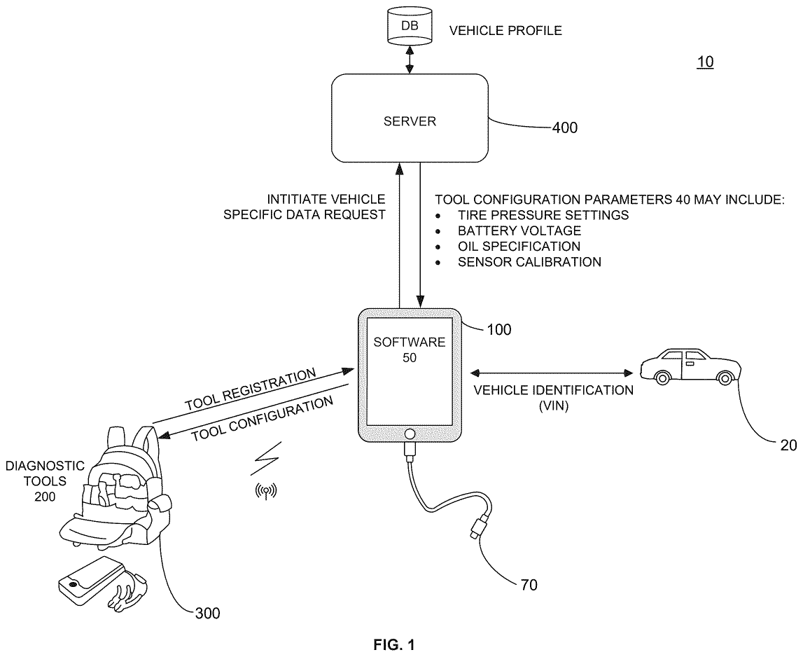

FIG. 1 illustrates an exemplary portable vehicle diagnostic system 10 according to one embodiment of the present disclosure. The portable system 10 comprises a hand-held device 100, which is communicatively coupled to a plurality of diagnostic tools 200, all housed within a single housing 300 such as backpack. The hand-held device 100 can be either integrated into housing 300 or can be a separate device, such as a mobile application (“app”) running on the user's smartphone or other mobile communication device. The hand-held device 100 acts as a central control unit of the system 10, overseeing the management, configuration, and monitoring of the diagnostic process, thus providing a seamless and user-friendly experience.

To support this functionality, a remote server 400 communicates with the hand-held device 100 and receives requests based on the vehicle's identification information such as VIN, model number, engine number or license plate. The remote server 400 responds by providing tool configuration parameters, diagnostic data, targeted assistance, and other relevant information to the hand-held device 100 to address the user's needs.

### Vehicle Identification and Tool Configuration

To provide such information, the remote server 400 manages a database of vehicle profiles. Each time a vehicle 20 is scanned for its vehicle identification information—either using the hand-held device's built-in camera or by connecting to the vehicle's On-Board Diagnostics (OBD) port—the vehicle identification information is uploaded to the remote server 400 to retrieve vehicle-specific data 30. This vehicle-specific data 30 includes tool configuration parameters 40 tailored to the associated vehicle, which are returned to the hand-held device 100.

The tool configuration parameters 40 may include tire pressure settings, battery voltage, oil specifications, sensor calibration, and more. In alternate embodiments, the portable system 10 is further designed to store retrieved tool configuration parameters 40 locally on the hand-held device 100, ensuring continued functionality even when there is limited or no connectivity, such as during mobile diagnostics in remote areas.

The system 10 is also capable of registering a variety of diagnostic tools 200, which are communicatively coupled to the hand-held device 100. These diagnostic tools 200 may include, but are not limited to, tire inflators, battery jumpers, tire pressure monitoring system (TPMS) sensors, fuel injection testers, climate control devices, engine analyzers, and diagnostic scanners.

The hand-held device 100 is equipped with specialized software 50 that supports the automatic registration and creation of tool profiles upon connection of diagnostic tools. It interfaces with these tools wirelessly or through a universal connector port 70. The universal connector port 70 ensures flexible compatibility with various diagnostic tools 200, allowing for both power delivery and data transmission.

The software interface on the hand-held device 100 provides an intuitive, real-time view of the diagnostic process, alerting users to any issues and guiding technicians through the necessary steps for resolution.

### Tool Configuration and Real-Time Diagnostics

The tool profiles created by the hand-held device 100 contains critical data such as the tool's capabilities, the diagnostic data it collects, and its operational parameters. The tool profile also tracks the tool's firmware version, maintenance history, and any updates applied.

Once the vehicle-specific tool configuration parameters 40 are retrieved from the remote server 400, and the diagnostic tools 200 are registered, the hand-held device 100 automatically configures the diagnostic tools 200 to implement specific diagnostic functions that are specific the current detected vehicle. These functions may include checking the health of specific vehicle components, such as tire pressure or battery voltage.

For example, when a tire inflator is connected, the hand-held device 100 retrieves the recommended tire pressure values from the tool's configuration parameters 40 and adjusts the inflator accordingly. If the system detects low tire pressure, it will automatically inflate the tire to the correct PSI, eliminating the need for manual adjustments. Similarly, when a battery jumper is connected, the hand-held device 100 checks the vehicle's battery voltage and adjusts the jumper to deliver the appropriate voltage and current for a safe jump-start.

The plug-and-play capability of the portable vehicle diagnostic system is a significant feature that enhances user convenience and system efficiency. This capability allows diagnostic tools to be automatically recognized and configured by the hand-held device upon connection, whether through wired or wireless means. The system's architecture includes a universal connector port and wireless communication protocols that facilitate seamless integration of various diagnostic tools, such as tire inflators, battery testers, and OBD-II scanners. Upon engagement with the backpack, the hand-held computing device automatically allocates hardware resources to the connected diagnostic tools, ensuring they are ready for immediate use without requiring manual setup or configuration. This automatic resource allocation is achieved through a combination of embedded software and firmware within the hand-held device, which identifies each tool's specific identifier and functionality, thereby establishing a tool profile that includes operational parameters and diagnostic capabilities. This plug-and-play functionality not only simplifies the diagnostic process but also minimizes the potential for user error, as the system autonomously manages tool configuration and operation based on the vehicle's particular diagnostic needs.

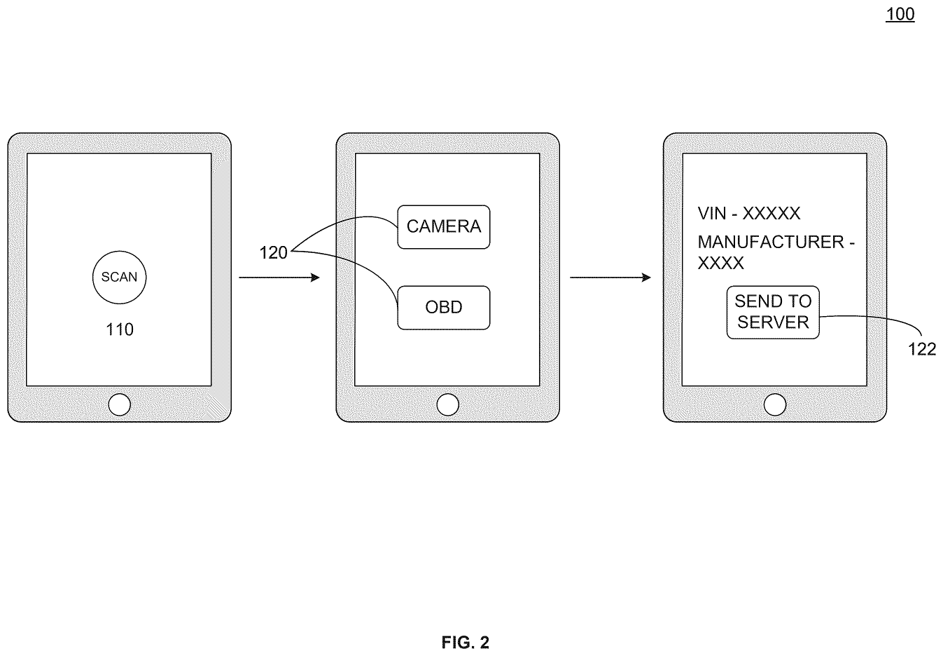

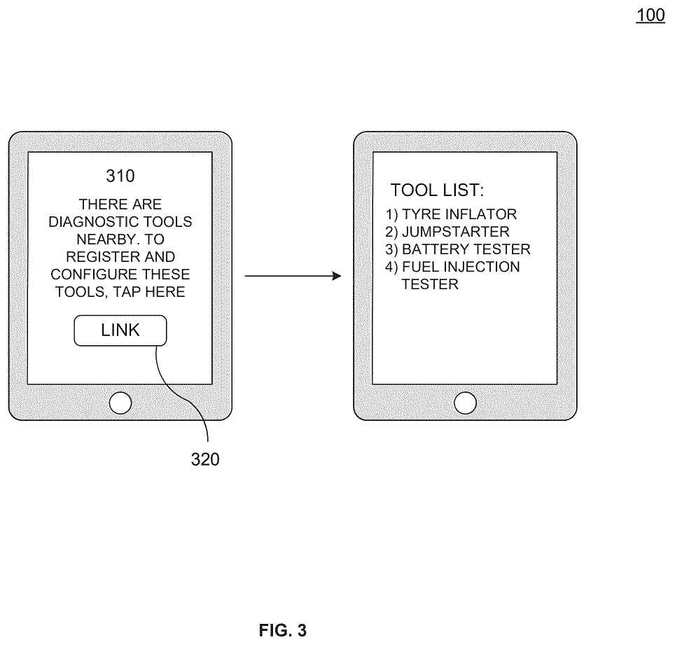

FIG. 2 shows a sequence of screenshots of the hand-held device 100 according to an embodiment of the present disclosure, in relation to obtaining vehicle-specific data. In the first view (leftmost), the hand-held device's software interface displays a “Scan” button 110. For example, consider a user on a road trip who notices a tire pressure warning. The user taps the “Scan” button 110 to initiate the process.

In response, the software interface transitions to the second view (center), displaying options 120 for identifying the Vehicle Identification information such as VIN, model number, engine number or license plate. The user can choose either the camera option, to scan the information label, license plate, or the OBD option, which connects to the vehicle's OBD port to extract data directly from the vehicle's ECU.

Once the vehicle identification information is identified, the software interface moves to the third view (rightmost), where the user is prompted to send the vehicle identification information to a remote server 400. The remote server 400 then returns vehicle-specific data, including tailored tool configuration parameters 40 such as tire pressure settings, battery voltage, and more. This information is also stored locally on the hand-held device 100 for offline functionality in areas with limited connectivity.

FIG. 3 shows a sequence of screenshots of the hand-held device 100 in relation to registering a plurality of diagnostic tools 200. Having been derived from the remote server 400, as described above, the tool configuration parameters 40 may be correlated with the plurality of diagnostic tools 200 for tool configuration.

In the first view of FIG. 3, the software interface of the hand-held device 100 automatically displays a notification 310. In the illustrated example, the notification 310 says, “There are diagnostic tools nearby. To register and configure these tools, tap here.” Continuing with our example from above, the user on the road trip may have completed the process of retrieving tool configuration parameters 40 on the hand-held device 100. Moments later, the user receives the notification 310 and taps the link 320.

In response to the vehicle owner's interaction with the link 320, the hand-held device 100 registers a plurality of diagnostic tools 200 which are contained with the portable and/or wearable housing. The diagnostic tools 200 are automatically detected when connected to the hand-held device 100, and the hand-held device 100 assigns a unique identifier to each tool. The hand-held device 100 then generates a tool profile for each tool, which contains critical data such as the tool's capabilities, the diagnostic data it collects, and its operational parameters. Based on the tool configuration parameters 40 retrieved from the remote server 400, the hand-held device 100 then automatically configures the diagnostic tools 200 to match the vehicle's specific needs and displays a list of tools on the software interface of the hand-held device 100, as shown in the second view of FIG. 3.

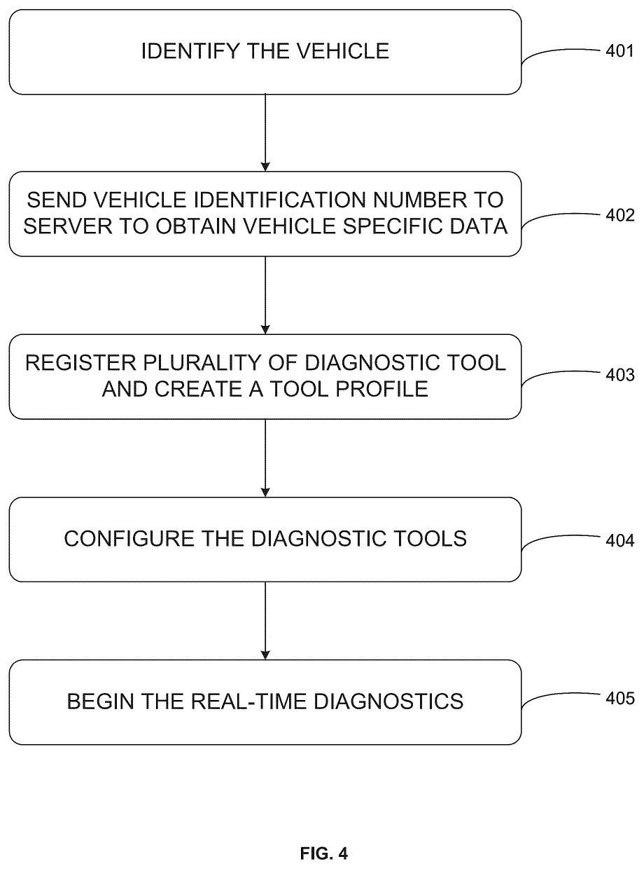

### Operational Flow (FIGS. 4 & 5)

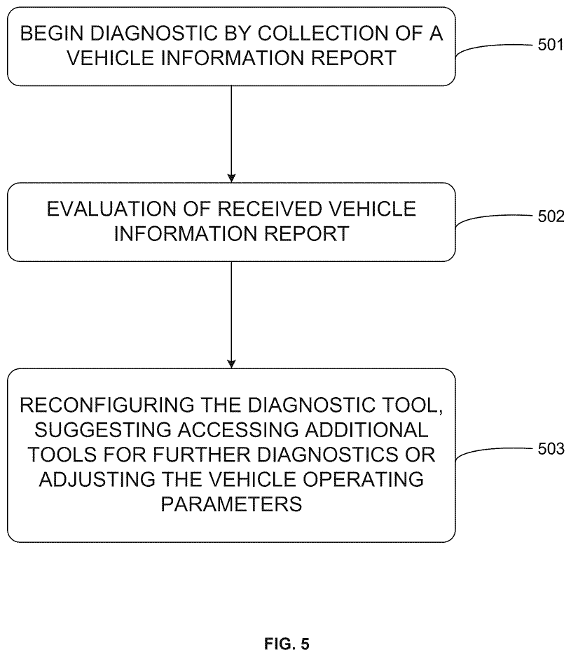

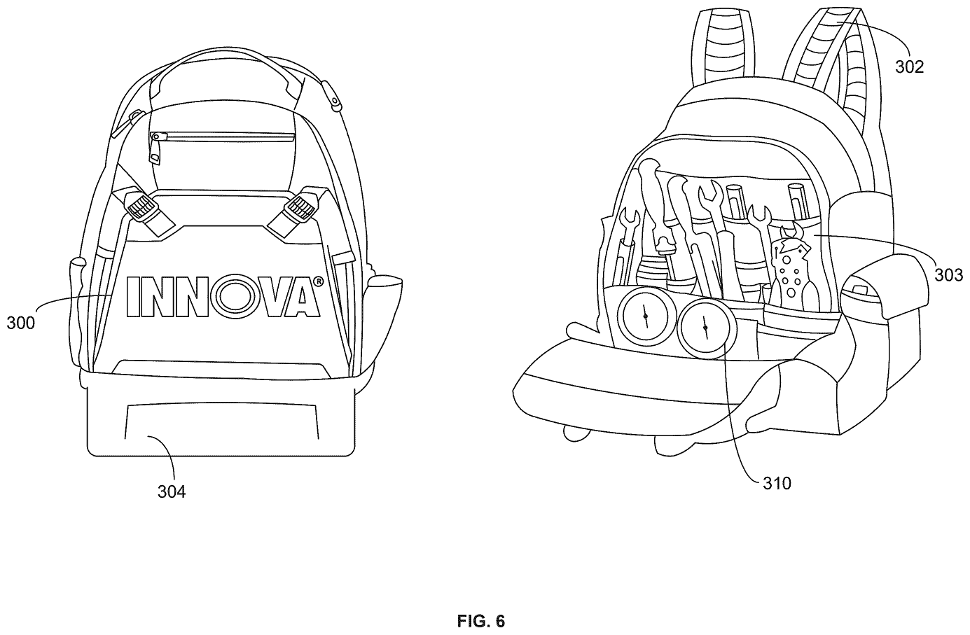

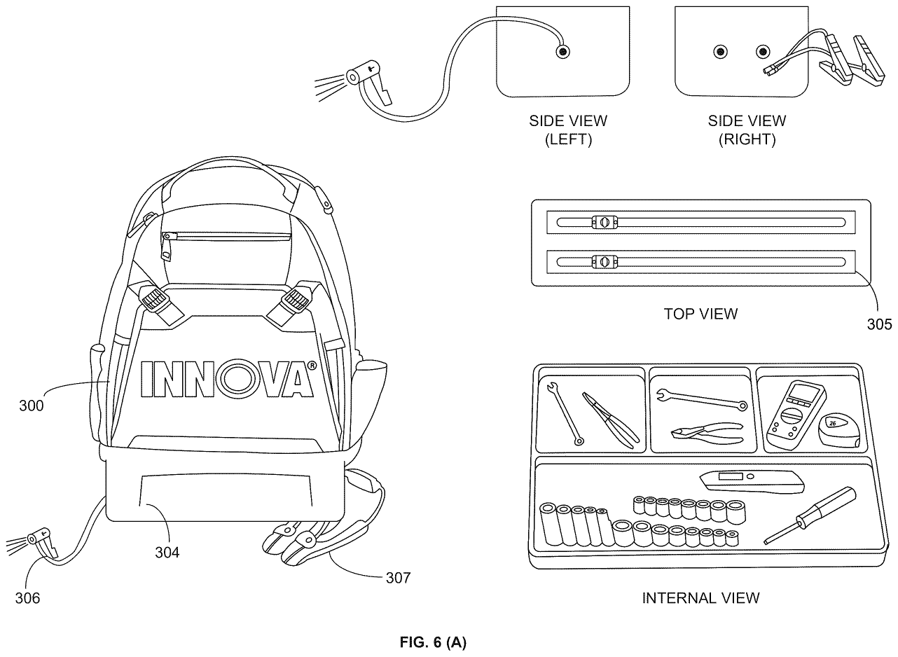

FIG. 4 shows an example operational flow according to an embodiment of the present disclosure, with FIG. 5 showing example sub-operational flows of steps 405. The operational flow of FIGS. 4-5 may be performed, in whole or in part, by one or more elements of the system 10 shown and described in relation to FIGS. 1-3. In particular, the operational flow may be performed by the hand-held device 100.

The operational flow may begin with the identification of the vehicle undergoing diagnostics (step 401). Typically, the portable system 10 identifies the vehicle by receiving its Vehicle Identification information such as VIN which is easily captured using the hand-held device's 100 built-in camera by scanning a VIN label or license plate on the vehicle. Alternatively, if the VIN or license plate is unavailable, the hand-held device 100 can be connected directly to the vehicle's On-Board Diagnostics (OBD) port, allowing the portable system 10 to extract essential vehicle data directly from the vehicle's Electronic Control Unit (ECU).

Once the vehicle 20 is identified, the hand-held device 100 sends the vehicle identification information (VIN) to a remote server 400, where it retrieves detailed, vehicle-specific information 30 (step 402). The vehicle-specific information 30 includes tool configuration parameters 40 tailored to the specific vehicle. These tool configuration parameters 40 may include tire pressure settings, battery voltage, oil specifications, sensor calibration, and more. The portable system 10 is also designed to store this information locally on the hand-held device 100, ensuring continued functionality even when there is limited or no connectivity, such as during mobile diagnostics in remote areas.

Upon obtaining the vehicle-specific data 30, the system 10 registers a plurality of diagnostic tools 200 that are communicatively coupled to the hand-held device 100 (step 403). These diagnostic tools 200 may include, but are not limited to, tire inflators, battery jumpers, tire pressure monitoring system (TPMS) sensors, fuel injection testers, engine analyzers, climate control devices, and diagnostic scanners. Each tool is automatically detected when connected to the hand-held device 100 and is assigned a unique identifier. The hand-held device then generates a tool profile for each device, which contains critical data such as the tool's capabilities, the diagnostic data it collects, and its operational parameters. The tool profile also tracks the tool's firmware version, maintenance history, and any updates applied.

Based on the tool configuration parameters 40 retrieved from the remote server 400, the hand-held device 100 then automatically configures the diagnostic tools 200 to match the vehicle's specific needs (step 404).

Once the diagnostic tools 200 are properly registered and configured, the hand-held device 100 begins real-time diagnostics. The hand-held device 100 collects data from the connected diagnostic tools 200 to assess various vehicle components (step 405), such as tire pressure, battery health, engine performance, and sensor calibration.

For instance, if a tire inflator is connected, the hand-held device 100 retrieves the recommended tire pressure values from the tool's configuration parameters 40 and configures the inflator to achieve the correct PSI. If the system detects low tire pressure, it will automatically adjust the inflator to inflate the tire to the correct pressure, eliminating the need for the user to manually adjust the settings. Similarly, if a battery jumper is connected, the system checks the vehicle's battery voltage and adjusts the jumper to deliver the appropriate voltage and current for a safe jump-start.

Should any issues be detected during the diagnostic process; the hand-held device 100 not only displays the problem but may also recommend corrective actions. For example, if the hand-held device 100 detects low battery voltage, it may prompt the user to use the battery jumper to initiate a jump-start. If low tire pressure is detected, the hand-held device 100 will recommend inflating the tires to the specified pressure. In some cases, the hand-held device 100 can automatically adjust the settings of the diagnostic tools 200 to resolve the issue—for instance, adjusting the tire inflator to increase tire pressure or recalibrating the battery jumper to provide the correct output for the specific vehicle.

The diagnostic process of step 405 described above, is further explained in FIG. 5. The process begins with the collection of a vehicle information report (Step 501) which includes diagnostic data from multiple diagnostic tools. The vehicle information report can be triggered in multiple ways, such as when a diagnostic tool detects an issue with a vehicle component (e.g., low tire pressure or a faulty sensor). Alternatively, a remote technician may initiate the report collection after reviewing initial diagnostic data and requesting additional vehicle status information.

Once the vehicle information report is collected, the hand-held device 100 evaluates the data (Step 502) and may automatically reconfigure the diagnostic tool, suggest accessing additional tools for further diagnostics or adjust the vehicle operating parameters (Step 503).

The settings of connected diagnostic tools such as a tire inflator, can be adjusted to target specific parameters (e.g., tire pressure) based on the retrieved tool configuration parameters 40.

Furthermore, hand-held device 100 may recommend adjustments to vehicle operating parameters, such as tire pressure, engine settings, sensor calibration, or fuel mixture, to optimize performance.

The evaluation of the collected data may be performed by the remote server 400, which provides instructions for reconfiguring diagnostic tools or adjusting vehicle parameters. In some cases, the hand-held device 100 automatically reconfigures the diagnostic tools based on the remote server's analysis.

For example, the hand-held device 100 may send commands to the vehicle's On-Board Diagnostics (OBD) system to modify parameters like tire pressure, HVAC settings, or engine performance. After adjustments are made, the hand-held device 100 generates a feedback report, which is uploaded to the remote server 400 for further analysis by a technician.

Additionally, the method may involve the use of multiple diagnostic tools, with the system generating a list of recommended repairs or maintenance actions based on the collected diagnostic data. The hand-held device 100 can also suggest additional diagnostic tools as needed, based on the vehicle's specific requirements, and it is capable of sending alerts to a remote technician or user if issues outside of predetermined thresholds are detected, enabling real-time troubleshooting or guidance. In certain cases, the hand-held device 100 can automatically adjust vehicle operating parameters or provide step-by-step instructions for manual adjustments.

The method further supports real-time diagnostics, displaying live data from connected tools, such as tire pressure or battery voltage, while offering recommendations for adjustments tailored to the vehicle's needs.

The system's cloud-based connectivity enhances its diagnostic capabilities. In cases of complex issues, the hand-held device 100 can upload the collected diagnostic data to a remote server 400, where technicians can review the data and offer expert guidance. This is particularly useful for remote or hard-to-reach locations, where a technician may not be physically present. The technician can remotely analyse the diagnostic report, provide troubleshooting steps, and, in some cases, reconfigure the diagnostic tools to collect additional data, conduct more in-depth tests, or adjust settings in real-time. For instance, if the system detects a malfunctioning sensor and the diagnostic tools do not provide sufficient information, the technician can remotely adjust the tool settings to gather more detailed data or initiate further tests.

The system may also make automatic adjustments or perform repairs based on the diagnostic data collected. For example, if a faulty tire pressure sensor is detected, the hand-held device can automatically connect to the vehicle's TPMS system and reprogram the sensor, ensuring it functions properly within the vehicle's system. Additionally, if the engine is found to be running inefficiently, the hand-held device can recommend, or even automatically implement, adjustments to vehicle parameters such as idle speed, fuel injection timing, or ignition settings to optimize performance.

An important feature of the vehicle diagnostic system 10 is its ability to track the usage and performance of each diagnostic tool. The hand-held device 100 logs each tool's usage, including when it was last used, how frequently it has been used, and whether it requires maintenance or calibration. For instance, if a battery jumper has been used frequently, the system will notify the user that the tool may require inspection or recalibration to maintain its performance. The system also tracks tool firmware versions and provides notifications when updates are available. Updates for both the hand-held device and diagnostic tools are delivered via the cloud, ensuring that the system is always equipped with the latest software and diagnostic capabilities.

Beyond diagnostics, the system 10 offers various vehicle maintenance and troubleshooting features. The diagnostic reports generated by the system provide detailed insights into the vehicle's condition, including the performance of each connected diagnostic tool and any recommended adjustments to vehicle parameters. These reports can be saved locally on the hand-held device or uploaded to the remote server for further review by remote technicians. The system also maintains a historical record of past diagnostics, allowing users to track vehicle performance over time. This historical data is valuable for identifying recurring issues and anticipating future maintenance needs. For example, if a recurring issue with tire pressure is detected, a mechanic can investigate further to determine if the problem is due to faulty sensors, tire wear, or another underlying cause.

In addition to vehicle diagnostics, the system supports a wide range of vehicle programming and configuration tasks. It can be used to program and calibrate various vehicle components, including sensors, electronic control modules (ECMs), and vehicle-specific settings such as TPMS, fuel injectors, and engine control units (ECUs). For instance, when a TPMS sensor is replaced, the system can retrieve the correct programming parameters from the remote server and ensure that the new sensor is correctly programmed and synchronized with the vehicle's system. Similarly, the system can reprogram the vehicle's ECU to accommodate changes in vehicle configuration, such as the installation of aftermarket parts.

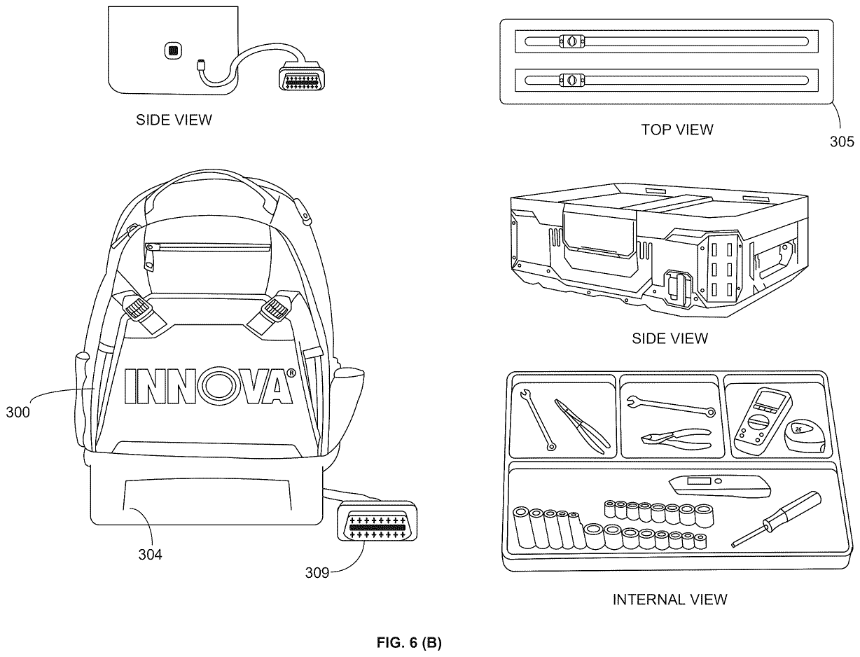

FIG. 6 illustrates an exemplary portable and multifunctional portable and/or wearable backpack housing 300, which serves as a convenient and secure solution for storing and carrying various diagnostic tools and equipment. The design of the backpack housing 300 is tailored to offer easy mobility, ensuring that users can access essential tools for on-site diagnostics, maintenance, and emergency repairs, regardless of location. The housing 300 is constructed from durable, weather-resistant materials that provide protection for the tools and components inside, safeguarding them from moisture, dirt, and physical impacts. The unique design of the backpack features padded shoulder straps 302 and a breathable back panel, ensuring that weight is evenly distributed across the user's body to reduce strain and improve comfort during extended use. The backpack is optimized for mobility, enabling the user to move freely while carrying the necessary tools for quick access during diagnostic procedures or repair tasks. The interior of the backpack housing 300 is equipped with multiple compartments 303, each designed to hold a wide range of diagnostic tools such as tire inflators, battery jumpers, tire pressure monitoring system (TPMS) sensors, fuel injection testers, climate control devices, engine analyzers, diagnostic scanners, sockets, wrenches, electrical testers, and other specialized equipment, all stored securely to minimize the risk of tool damage or loss.

In addition to its primary function of storing diagnostic tools, the backpack housing 300 incorporates a removable magnetic compartment/tray 304 that is configured for storing additional diagnostic tools and can be used to house key emergency and diagnostic components. This magnetic compartment/tray is securely attached below the main housing by a locking mechanism 305, ensuring a stable connection during use, yet allowing for easy detachment when needed. The locking mechanism can be a latch-based system, a sliding groove system, or a novel rail system integrated with Tire Pressure Monitoring System (TPMS) sensors or other sub-systems. This rail system not only provides robust mechanical support but also facilitates enhanced connectivity for real-time monitoring and diagnostics.

In one configuration, as shown in FIG. 6(a), the compartment/tray 304 stores essential emergency tools, including an integrated tire pressure inflator 306, a battery jump-start system 307, and a DC power supply—all critical for automotive or industrial emergency repairs. The integrated tire pressure inflator 306 is enhanced by the TPMS connectivity enabled by the rail system, allowing users to monitor tire pressure data in real-time via a connected device. This ensures accurate and timely inflation during roadside emergencies or routine maintenance. The battery jump-start system 307 includes jumper cables and a built-in tester, enabling users to safely and effectively assist with starting a vehicle or equipment with a drained battery.

In an alternative configuration, as depicted in FIG. 6(b), the lower compartment 304 is equipped with an OBD port 309 for connecting to an On-Board Diagnostics (OBD) system or additional storage. The integrated rail system enhances functionality by providing a unified interface for real-time diagnostics, enabling seamless error code reading and system scanning. The modular design of the compartment ensures that these tools remain accessible without the need to disturb or remove the primary diagnostic kit stored in the upper section of the backpack.

The modular lower compartment/tray 304 of the backpack housing 300 is designed for quick removal, providing users with access to vital emergency and diagnostic tools in configuration 6(a), such as the battery jump-start system 307 and integrated tire inflator 306, independently from the main backpack body. In an alternative configuration, as shown in 6(b), the lower compartment 304 featuring an OBD port 309 is detachable, enabling wireless Vehicle Communication Interface (VCI) connectivity for enhanced diagnostic capabilities. The integration of the rail system at the compartment's base provides secure mounting with a latch based locking mechanisms and connectivity for TPMS or other sensors, optimizing the diagnostic and emergency tool suite for advanced automotive service needs.

This removable design also facilitates wireless app-based battery testing and jump-starting functionality, and real-time TPMS monitoring. Users can perform remote diagnostics, initiate jump-start procedures, and access tire pressure data directly via a smartphone app, enhancing convenience and flexibility during on-site service and emergency situations. The innovative rail system at the lower compartment base simplifies tool organization and accessibility while offering mechanical robustness and enhanced connectivity, ensuring rapid deployment and efficient performance.

The backpack housing 300 also includes integrated GPS functionality 310, which provides location-based support during diagnostic and emergency situations. The GPS system transmits the backpack's current location to a remote technician or support team, ensuring that the technician can provide location-specific assistance or dispatch additional resources if necessary. This feature is particularly beneficial in emergency roadside scenarios, where precise location tracking is critical to ensuring timely and accurate support. The GPS functionality provides additional peace of mind for professionals working in remote or hard-to-reach locations, enabling real-time communication and assistance from remote teams.

The internal organization of the backpack 300 is designed to securely store each tool and component while ensuring easy accessibility. The layout incorporates dedicated compartments, straps, and mesh pockets, minimizing the risk of misplaced tools and promoting a well-ordered workspace.

FIG. 6(a) and 6(b) provide various views of the backpack housing 300, including top, side, and internal perspectives of the removable lower compartment 304 in two distinct configurations. The side view illustrates the connection ports for either the tire inflator 306, battery jump-start system 307 or the OBD port 309, while the top view highlights the locking mechanism 305 (such as a rail system, a slider or a latch based locking system) that secures the lower compartment to the main body of the backpack housing 300. The internal view details the arrangement of the tire inflator, battery jump-start system, DC power supply, and Wireless VCI/Bluetooth Scanner within the removable lower compartment, ensuring that each component is efficiently stored for immediate access during diagnostic or emergency repair tasks.

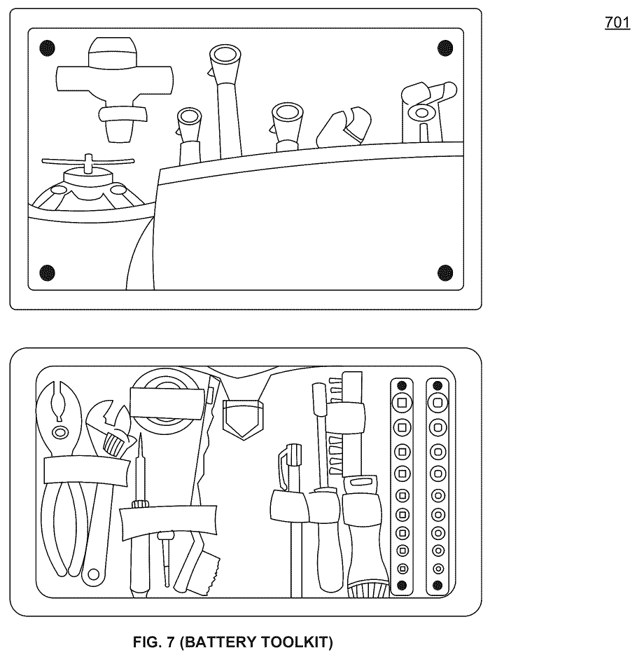

FIG. 7 illustrates the internal structure of the remote battery tool kit 701 housed within the wearable backpack housing 300. The remote battery tool kit 701 is specifically designed to provide a fully organized and fully equipped solution for battery servicing and maintenance. The backpack housing 300 is constructed with durable, weather-resistant materials to protect the contents, while the design allows for ease of use. The backpack's compartment 303 securely houses the remote battery tool kit 701, which includes a range of tools essential for working with various battery types, such as 8 mm side-post and 10 mm top-post configurations commonly found in automotive and industrial applications. Specific sizes include those designed for 8 mm side-post batteries and 10 mm top-post batteries, ensuring compatibility with both standard and specialized battery setups. The kit includes a series of sockets, tailored to fit battery terminal bolts.

For non-standard battery configurations, the kit also includes components like 13 mm aftermarket battery terminals and battery hold-down bases, which are necessary for securing high-performance or custom battery types.

To facilitate the removal and installation of battery terminals, the kit 701 features an adjustable wrench, which provides versatility and ease of use across a variety of bolt sizes. The kit 701 also includes a battery terminal cleaner, an essential tool for removing corrosion, dirt, and other debris from battery terminals, ensuring optimal electrical conductivity and extending battery life.

Additionally, a battery terminal removal tool is provided to help users safely and efficiently detach battery cables from terminals, even when corrosion or rust has made the process more difficult. The internal storage system of the backpack housing 300 ensures that all these tools are securely organized and easy to access, reducing downtime and improving efficiency during service. The backpack may also include external straps or pockets for additional tools or accessories, increasing the kit's adaptability for different service tasks.

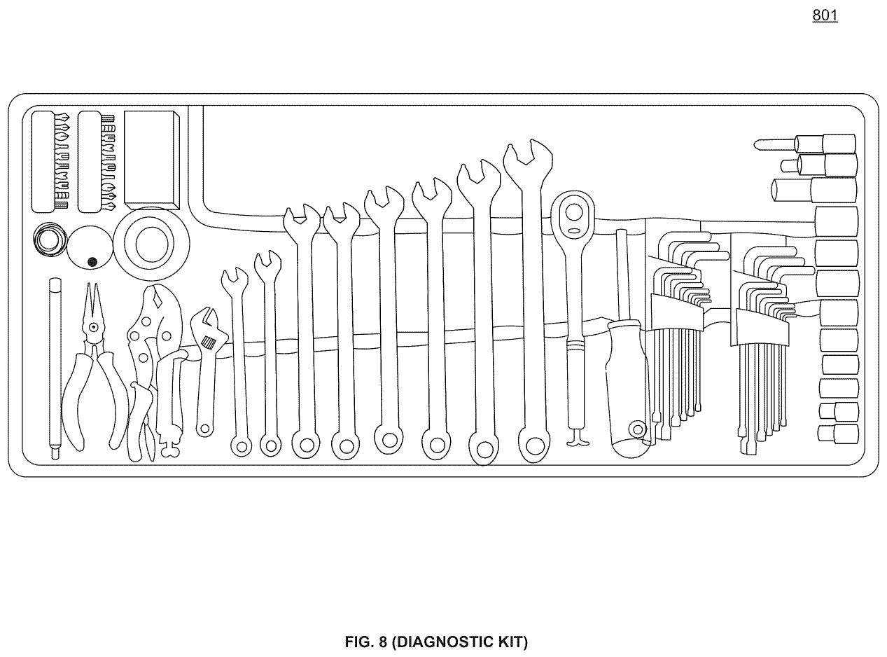

FIG. 8 illustrates the remote diagnostic kit 801 housed within the wearable backpack housing 300, providing a portable, well-organized, and comprehensive solution for diagnosing and servicing electrical and mechanical systems. The backpack housing 300 is constructed from rugged, weather-resistant materials, ensuring the safety and durability of the diagnostic tools stored inside. The backpack's compartment 303 houses the diagnostic kit 801, which includes a carefully selected range of tools and components for addressing a variety of electrical and mechanical issues typically encountered in automotive, industrial, or equipment diagnostics.

The diagnostic kit 801 includes a set of sockets, sized to fit the most commonly used fasteners in automotive and industrial applications. These sockets include sizes 8 mm, 10 mm, 12 mm, 13 mm, and 14 mm, providing versatility for working on a variety of bolts and fasteners. For accessing hard-to-reach areas, the kit 801 also includes an extension, which adds extra length and leverage for components that require additional reach. In combination with the sockets, the kit 801 features a ratchet with a ¼ inch drive, enabling users to apply precise torque for tightening or loosening fasteners, even in confined spaces.

The kit 801 also includes a set of wrenches in sizes 8 mm, 10 mm, 12 mm, 13 mm and 14 mm, which provide an alternative to the sockets when working in tighter spaces or when more manual control is required.

For electrical diagnostics, the kit 801 includes an electrical tester, which is crucial for checking voltage, continuity, and circuit integrity, allowing users to quickly identify issues like faulty wiring or malfunctioning components. The integrated electric tester, which can be a Test Light or model 3330, visually indicates the presence of electrical voltage, allowing users to easily verify whether power is properly flowing through a circuit. The internal organization of the diagnostic kit 801 ensures that each tool is securely stored and easily accessible. The backpack's internal compartments keep tools separated and organized, minimizing the time spent searching for the correct tool and increasing operational efficiency.

The backpack housing 300 may also feature exterior straps or pouches for extra storage, offering flexibility for carrying additional equipment or accessories. This all-in-one diagnostic kit 801 is ideal for professionals such as automotive technicians, field service workers, or DIY enthusiasts, providing a reliable, portable, and comprehensive solution for diagnosing and servicing electrical and mechanical systems.

The wearable backpack housing 300, with its fully equipped remote battery tool kit 701 and remote diagnostic kit 801, offers a versatile, portable solution for users. It provides an ergonomic, organized, and durable system that ensures tools are readily accessible, protected, and effectively used in various on-site diagnostics, emergency repairs, and maintenance tasks.

Ultimately, this invention provides a highly flexible, intelligent, and portable solution for vehicle diagnostics, maintenance, and repair. By combining cloud-based connectivity, real-time data analysis, automatic tool configuration, and remote technician support, the system simplifies vehicle maintenance for both consumers and professionals. Whether performing routine diagnostics, troubleshooting complex issues in the field, or receiving expert guidance remotely, the system offers an efficient, accessible, and effective solution for modern vehicle maintenance and repair.

The functionality described above in relation to the components of the system 10 shown in FIGS. 1-3 and the operational flow described in relation to FIG. 4-5 and throughout the disclosure may be wholly or partly embodied in one or more computers, including a processor (e.g., a CPU), a system memory (e.g., RAM), and a hard drive or other secondary storage device. The processor may execute one or more computer programs, which may be tangibly embodied along with an operating system in a computer-readable medium, e.g., the secondary storage device. The operating system and computer programs may be loaded from the secondary storage device into the system memory to be executed by the processor. The computer may further include a network interface for network communication between the computer and external devices (e.g., over the Internet), such as between the hand-held device 100 and the server 400. To the extent that functionality may be performed at the server 400 rather than by the hand-held device 100, the server 400 may comprise multiple physical servers and other computers that communicate with each other to perform the described functionality.

The above computer programs may comprise program instructions which, when executed by the processor, cause the processor to perform operations in accordance with the various embodiments of the present disclosure. The computer programs may be provided to the secondary storage by or otherwise reside on an external computer-readable medium such as a DVD-ROM, an optical recording medium such as a CD or Blu-ray Disk, a magneto-optic recording medium such as an MO, a semiconductor memory such as an IC card, a tape medium, a mechanically encoded medium such as a punch card, etc. Other examples of computer-readable media that may store programs in relation to the disclosed embodiments include a RAM or hard disk in a server system connected to a communication network such as a dedicated network or the Internet, with the program being provided to the computer via the network. Such program storage media may, in some embodiments, be non-transitory, thus excluding transitory signals per se, such as radio waves or other electromagnetic waves. Examples of program instructions stored on a computer-readable medium may include, in addition to code executable by a processor, state information for execution by programmable circuitry such as a field-programmable gate array (FPGA) or programmable logic array (PLA).

The above description is given by way of example, and not limitation. Given the above disclosure, one skilled in the art could devise variations that are within the scope and spirit of the invention disclosed herein. Further, the various features of the embodiments disclosed herein can be used alone or in varying combinations with each other and are not intended to be limited to the specific combination described herein. Thus, the scope of the claims is not to be limited by the illustrated embodiments.

What is claimed is:

1. A method for performing vehicle diagnostics using a portable system, which includes a hand-held computing device communicatively engageable to a vehicle under test and to one or more diagnostic tools, wherein the diagnostic tools are releasably engageable to the backpack, the method comprising:
receiving a vehicle identification information from a vehicle under test at the hand-held computing device;
receiving tool configuration parameters associated with the vehicle under test at the hand-held device;
establishing a tool profile associated with at least one of the diagnostic tools, the profile including a unique tool identifier and an identification of a functionality(s) associated with the at least one of the diagnostic tools;
wirelessly configuring the at least one of the diagnostic tools to implement a selected diagnostic functionality(s) on the vehicle under test and communicate test results to the hand-held computing device, where the configured diagnostic tool has been associated with the selected diagnostic functionality(s); and
generating a diagnostic report associated with the implemented diagnostic functionality(s).

2. The method of claim 1, wherein the vehicle identification information is received by scanning a VIN label using a camera integrated into the hand-held device.

3. The method of claim 1, wherein the vehicle identification information is received by connecting the hand-held device to a vehicle's diagnostic port.

4. The method of claim 1, wherein the hand-held computing device automatically allocates hardware resources to the diagnostic tools upon engagement of the diagnostic tool with the backpack.

5. The method of claim 1, wherein the one or more of the diagnostic tools are configurable to measure parameters associated with at least one of tire pressure settings, battery voltage, oil levels and sensor calibration data associated with the vehicle under test.

6. The method of claim 1, wherein the diagnostic tools are selected from the group consisting of a tire inflator, a battery jump starter, battery tester, OBD-II scanner, basic tools, electric tester, a climate control device, an engine analyzer, and a fuel injector tester.

7. The method of claim 5, wherein the diagnostic tools are configurable to reset at least one of the measured parameters.

8. The method of claim 5, wherein the diagnostic tools are autonomously configurable in response to receipt of the vehicle identification information at the hand-held computing device.

9. The method of claim 6, wherein the battery jump starter is configurable to deliver a required voltage or current suitable for jump-starting the vehicle's battery.

10. The method of claim 6, wherein the climate control device is configurable to diagnose and adjust the vehicle's heating, ventilation, or air conditioning (HVAC) system, based on the vehicle identification information and the tool configuration parameters associated with the vehicle under test.

11. The method of claim 1, wherein the diagnostic tools are plug-and-play devices that automatically communicate with the hand-held device and are configurable upon being linked to the hand-held computing device.

12. The method of claim 1, wherein establishing a tool profile with the hand-held computing device tracks usage and performance of each tool, sorted in accordance with the unique identifier associated with each diagnostic tool.

13. The method of claim 1, wherein the hand-held device is further configured to store the retrieved tool configuration parameters locally on the hand-held device for use in the absence of connectivity between the hand-held device and a remote server.

14. The method of claim 1, wherein the diagnostic report includes information about the status of the vehicle's tires, engine, battery, and other key vehicle systems.

15. The method of claim 1, wherein the diagnostic report is stored on a cloud-based system accessible by the hand-held device for further analysis or for sharing with a remote technician.

16. The method of claim 1, wherein the hand-held device is configured to automatically update the diagnostic tool profiles whenever new tool configuration parameters are received at the hand-held computing device

17. The method of claim 5, wherein the diagnostic function includes periodically measuring at least one of the parameters.

18. The method of claim 17, wherein the diagnostic report includes an update on the measured parameter(s).

19. The method of claim 1, wherein said wirelessly configuring the at least one of the diagnostic tools is based at last in part on the vehicle identification information.

20. The method of claim 19, wherein said wirelessly configuring the at least one of the diagnostic tools is performed automatically in response to the receipt of the vehicle identification information.

21. The method of claim 19, wherein said wirelessly configuring the at least one of the diagnostic tools is performed automatically in response to the engagement of the diagnostic tool with the backpack.

22. The method of claim 19, wherein said wirelessly configuring the at least one of the diagnostic tools includes tailoring configuration parameters of the tool to the vehicle under test according to the vehicle identification information.

23. A portable vehicle diagnostic system, comprising:
one or more diagnostic tools; and
a hand-held computing device communicatively engageable to a vehicle under test and to the one or more diagnostic tools, wherein the hand-held computing device is configured to receive vehicle identification information from a vehicle under test, receive tool configuration parameters associated with the vehicle under test, and establish a tool profile associated with at least one of the one or more diagnostic tools, the profile including a unique tool identifier and an identification of a functionality(s) associated with the at least one of the one or more diagnostic tools;
wherein the hand-held computing device is further configured to automatically configure the at least one of the one or more diagnostic tools, upon being communicatively engaged therewith, to implement a selected diagnostic functionality(s) on the vehicle under test and communicate test results to the hand-held computing device, where the configured diagnostic tool has been associated with the selected diagnostic functionality(s), and to generate a diagnostic report associated with the implemented diagnostic functionality(s).

24. A portable vehicle diagnostic system, comprising:
one or more diagnostic tools; and
a hand-held computing device communicatively engageable to a vehicle under test and to the one or more diagnostic tools, wherein the hand-held computing device is configured to receive vehicle identification information from a vehicle under test, receive tool configuration parameters associated with the vehicle under test, establish a tool profile associated with at least one of the one or more diagnostic tools, the profile including a unique tool identifier and an identification of a functionality(s) associated with the at least one of the one or more diagnostic tools, configure the at least one of the one or more diagnostic tools to implement a selected diagnostic functionality(s) on the vehicle under test and communicate test results to the hand-held computing device, where the configured diagnostic tool has been associated with the selected diagnostic functionality(s), and generate a diagnostic report associated with the implemented diagnostic functionality(s);
wherein the hand-held computing device is further configured to automatically allocate hardware resources to the at least one of the one or more diagnostic tools upon being communicatively engaged therewith.
